(19) United States
(12) Patent Application Publication
(10) Pub. No.: US 2004/0033811 A1
(43) Pub. Date: Feb. 19, 2004

(54) Messaging management system and method for users roaming in a multi-campus enterprise mobile communication environment

(76) Inventors: Chen-Fang Tsai, Hsinchu (TW); Chun-Chi Lo, Yun-Liu (TW); Wan-Chun Liu, Tau-Yuan (TW); Chun-Shiow Chen, Hsinchu (TW)

Correspondence Address: STEVENS DAVIS MILLER & MOSHER, LLP, 1615 L STREET, NW, SUITE 850, WASHINGTON, DC, 20036, US

(21) Appl. No.: 10/640,631

(22) Filed: Aug. 14, 2003

Related U.S. Application Data
(62) Division of application No. 09/699,988, filed on Oct. 27, 2000.

(30) Foreign Application Priority Data
Nov. 5, 1999 (TW) 88119326

(51) Int. Cl. H04M 1/00

(52) U.S. Cl. 455/554.1; 455/555; 455/560; 455/432.1

(57) ABSTRACT

The present invention relates to a messaging management system and method for users roaming in a multi-campus enterprise mobile communication environment, wherein the voice messaging is transported only on demand so as to reduce the bandwidth requirement for the digital data network to lower the enterprise's operation cost, and a Voice Messaging System Call-Back (VMS Call-Back) is provided to render the present invention as a user friendly system so as to prevent the users from the problem of uncertain waiting time when the users listen to the voice messages which are transported among different campuses. The system and method of the present invention not only significantly lower the unnecessary transport of the voice messaging but also can operate under the condition of insufficient digital data network bandwidth, which can reduce the cost for network bandwidth and loosen up the operation requirements for the voice messaging system. Besides, the subscribers of the present invention are not required to memorize several sets of representative numbers for the VMS at different campuses, which renders the present invention a user friendly and competitive system.

### BACKGROUND OF THE INVENTION

1. Field of the Invention

The present invention relates to a messaging management system and, more particularly, to a messaging management system and method for users roaming in a multi-campus enterprise mobile communication environment, wherein the voice messaging is transported only on demand so as to reduce the bandwidth requirements for the digital data network to lower the enterprise operation cost, and a Voice Messaging System Call-Back (VMS Call-Back) is provided to render the present invention as a user friendly system so as to prevent the subscribers from the problem of uncertain waiting time when the subscribers listen to the voice messages which are transported among different campuses.

2. Description of the Related Art

In practice it has been found that 70% of the calls made to a mobile network fail one way or the other. If the mobile network includes a voice messaging system (VMS), these failed calls create traffic in the VMS system (receiving and discharging messages). Thus, the voice messaging system involves transmitting a lot of information from a subscriber to the voice mail and vice versa. If the subscriber has a home station which is different from the one within which he or she is presently located, it is necessary to carry the traffic over inter-station trunk connections back and forth between the voice messaging station and the subscriber.

In conventional private mobile communication network with voice messaging system, the transport of the voice messages are carried out through the digital data network constructed by private trunk among the different campuses. When the transport requirements increase, the capacity of the private trunk must be increased and the high bandwidth network is required, thereby increasing the communication cost for the enterprise.

Furthermore, when the enterprise provides a wireless communication environment and allows its subscribers to roam among multi-campuses, it is very important for the communication art how to store and manage the voice messaging for the subscribers. U.S. Pat. No. 5,751,792, issued to Chau et al. on May 22, 1998, discloses a system and method for storing and managing subscriber's voice messaging by utilizing a public switched telephone network (PSTN). According to U.S. Pat. No. 5,751,792, the system and method enable a message service provider to make a subscriber's messages stored at a home mailbox at a home node available at a roaming mailbox at a roaming node. When a subscriber accesses the messaging system at a roaming node to obtain his/her messages, the system establishes a roaming mailbox at the roaming node, copies the messages from the home mailbox to the roaming mailbox, and connects the subscriber to the roaming mailbox while copying the messages. Messages can be left for the subscriber by accessing any node in the messaging system which will transport the messages to the home mailbox at the home node as well as to any roaming mailbox that has been established at a roaming node. All voice messages stored in the roaming mailbox will be transported back to the subscriber's home mailbox.

U.S. Pat. No. 5,627,877, issued to Penttonen on May 6, 1997, discloses a system for storing and managing subscriber's voice messaging by utilizing a public mobile switch network. The system includes a plurality of mobile switching centers (MSC) and a home location register (HLR), wherein the VMS checks HLR repeatedly for the location of a subscriber and concludes on the basis of this information whether the subscriber has moved into the area of some other MSC for a period of time longer than a predetermined period of time, in a positive case, the old VMS transfers the subscriber-related information to the new VMS, thus accomplishing the automatic relocation of the subscriber's home station in connection with a new MSC.

The above mentioned U.S. Patents allow the multi-campus subscribers to access their voice messages during roaming. However, the conventional systems transport all voice messages, including unused one. Accordingly, when the transport requirements for the voice messages increase, the capacity of the private trunk must be increased and the high bandwidth network is required, thereby increasing the cost for the enterprise. Besides, when the system network is busy, the subscriber is unable to expect the correct time available for him/her. This causes the problem of uncertain waiting time when the subscribers listen to the voice messages which are transported among different campuses.

### SUMMARY OF THE INVENTION

It is a primary object of the present invention to provide a messaging management system and method for users roaming in a multi-campus enterprise mobile communication environment, wherein the voice messaging is transported only on demand so as to reduce the bandwidth requirement for the digital data network to lower the enterprise operation cost.

It is another object of the present invention to provide a messaging management system and method for users roaming in a multi-campus enterprise mobile communication environment, wherein a Voice Messaging System Call-Back (VMS Call-Back) is provided to render the present invention as a user friendly system so as to prevent the users from the problem of uncertain waiting time when the users listen to the voice messages which are transported among different campuses.

It is a further object of the present invention to provide a messaging management system and method for users roaming in a multi-campus enterprise mobile communication environment allowing the users to access their voice messaging system through an unique number for all campuses.

It is a further object of the present invention to provide a messaging management system and method for users roaming in a multi-campus enterprise mobile communication environment which can be carried out in a low bandwidth network environment.

The messaging management system for users roaming in a multi-campus enterprise mobile communication environment includes at least two campuses, and the description set forth below includes three campuses A, B and C to illustrate the novel features of present invention. As illustrated in FIG. 3, Campus A comprises a private branch exchange (PBX_{A}), a mobility manager (MM_{A}), a voice messaging system (VMS_{A}), a plurality of base stations (BS) and mobile phones. Between the mobility manager (MM_{A}) and the base stations (BS) is optionally provided with a base station controller to assist the mobility manager (MM_{A}) for controlling the transport of registration, call origination and call delivery from the mobile phones to the base station. The PBX_{A} is connected to a central office A which is part of public switched telephone network (PSTN). If the distance between the campuses is too long, there could be a toll switch located between central offices in the PSTN. If the distance between the campuses is not far away, their PBXs may be connected to the same central office and thus no toll switch will be contained in the inter-campus communication path. MM_{A} supports mobile communication capability and allows the mobile subscribers' registration, call origination, call forward and voice messaging. PBX_{A} controls the incoming and outgoing calls of PSTN and connects these calls to the wireless communication equipment, such as the BS. The storage and management of the voice messages of PSTN are connected through hunt group (HG) to VMS_{A} which provides the storage and access of the voice messages and other managing functions. Since the roaming information and voice messages for all campuses should be transported to one another, both VMS_{A} and MM_{A} are connected to a digital data network for transporting the roaming information and voice messages. It should be understood that campus B and campus C have the similar configuration as that of campus A. Description of campus B and campus C is eliminated due to its similarity to that of campus A. The mobility manager, as depicted in FIG. 4, mainly includes a central processing unit (CPU) controlling a switch fabric (SF), a data network interface adapter, a storage device, a memory and a base station interface adapter. The voice messaging system (VMS) mainly includes a central processing unit (CPU) controlling a switch fabric (SF), a data network interface adapter, a storage device, and a memory. The switch fabric of the voice messaging system includes tone or dual tone multi-frequency signal (DTMF) source for exchanging voice path to produce tone or to decode the subscribers' dialing number. The data network interface adapter is connected to a digital data network. The incoming hunt group (IHG) is the private line of the voice messaging system for accessing the voice messages and the outgoing hunt group (OHG) is the private line of the voice messaging system for call back. The base station interface adapter of the mobility manager is connected to the base station for processing the registration, call origination and call delivery of the mobile phones.

When the subscriber roams to another campus, the subscriber's mobile phone must be registered with the mobility manager of the roaming campus firstly. The mobility manager of the roaming campus might already have had all subscribers' information of the enterprise. If not, the mobility manager of the roaming campus can ask the subscriber's home campus through directory service for authentication so as to allow the roaming subscriber to register with the mobility manager. After registration, the mobility manager assigns a roaming number (RN) to the subscriber. Thereafter, all calls made to the roaming subscriber are forwarded to the roaming campus through the roaming number. The present invention utilizes the roaming number as the identifying number of the voice mail box such that the messages can be stored at the voice messaging system of the roaming campus and are not required to be forwarded to and stored at the home campus. This invention does not restrict the VMB identity to be a RN. It could also be any other numbering. The roaming subscriber is also not required to access his message from his home campus. Accordingly, the present invention significantly reduces the requirement for transporting the messages backward and forward between the roaming campus and the home campus and lowers the bandwidth requirement for the digital data network.

However, allowing the messages stored at the roaming campus results in the condition that the messages are distributed over various campuses. The present invention provides a novel system and method to use a unique VMS access number in all various campuses of the enterprise for accessing the voice messaging systems, which not only can avoid the subscriber from remembering several VMS access numbers but also enable the subscriber to obtain the newest and correct information for the voice messages by means of the management of the mobility manager. When the subscriber intends to listen to the messages left at the home campus but the bandwidth of the digital data network is not enough or too busy to transport the messages to the roaming campus in time, the present invention further provides a call back system and method to maintain the normal operation of the system and eliminate the requirement for increasing the capacity of the digital data network of the enterprise.

According to the present invention, the mobile subscribers are not required to arrange their voice mail box (VMB). After registered with the roaming campus, the RN assigned to the subscriber is used as the identification number for the roaming VMB. The roaming VMB and the home VMB belong to the same subscriber. Accordingly, the RN and the subscribers' directory number (DN) are corresponding with each other and the required corresponding information can be obtained from the mobility manager. Before the subscriber registered with the roaming campus, the newest message header is stored at his home campus. After registration with the roaming campus, the subscriber must obtain his message header from his home campus such that the subscriber is provided with the correct information. According to the present invention, the message body is not transported at the time of registration. After registration, all new message header will be stored at the VMS of the roaming campus such that the roaming campus begins to store the newest and the most complete information for the message header and the newly added voice message. If the subscriber belonging to campus A roams to campus B and subsequently to campus C, the VMS_{B} in previously roaming campus firstly transports the message header back to the VMS_{A} in the home campus such that the roaming subscriber can complete his registration without needing to wait for message body transportation. Message body transportation will take much longer time. The message body which is relatively much larger in message size, is stored at the spooling area firstly and will be transported later. When the information is stored at the spooling area, the space occupied by the message body will be released for other subscribers' use. Since the present invention is provided with call-back function, the actual message contents are allowed to be transported later.

The present invention utilizes the principle of transport on demand, wherein the messages stored at the roaming campus is played first when the subscriber intends to listen to his messages, and the messages are transported only when the messages, to that the subscriber at the roaming campus wants to listen, are stored at the home campus . If the subscriber at the roaming campus does not listen to the messages stored at the home campus, there is no requirement for transporting the messages and for occupying the storing space of the VMS of the roaming campus for storing the unused messages. In the same way, if the subscriber listens the messages stored at the roaming campus and then delete them, the messages are not required to be transported back to and occupy the storing space of VMS_{A}. The present invention further provides a call-back mechanism in such a manner that the messages requiring long transporting time can be continuously transported and the subscriber will not waste time for waiting. After the long messages are completely transported, the VMS calls back to the subscriber to continue to manage his messages. This renders the present invention as a user friendly system so as to prevent the subscribers from the problem of uncertain waiting time when the users listen to the voice messages which are transported among different campuses. For the sake of call back mechanism, the present invention does not rely on the high bandwidth network for transporting in-time messages. Accordingly, the present invention provides a messaging management system and method for users roaming in a multi-campus enterprise mobile communication environment which can be carried out in a low bandwidth network environment.

### BRIEF DESCRIPTION OF THE DRAWINGS

Other objects, advantages, and novel features of the invention will become more apparent from the following detailed description when taken in conjunction with the accompanying drawings.

FIG. 1 is a diagram showing the conventional enterprise environment for wire communication and voice message system;

FIG. 2 is a diagram showing the enterprise environment for mobile communication and voice message system;

FIG. 3 illustrates a diagram showing the multi-campus enterprise environment for mobile communication and voice message system;

FIG. 4 is a diagram showing the internal structures for the mobility manager and the voice message system;

FIG. 5 is a diagram showing the internal structures for the voice message system according to the present invention;

FIG. 6 is a flow chart showing the subscriber's registration with the roaming campus according to the present invention;

FIG. 7 is a flow chart showing the message recording according to the present invention;

FIG. 8 is a flow chart showing the listening and management of the voice messages according to the present invention;

FIG. 9 is a flow chart showing the listening and management of the unread voice messages according to the present invention; and

FIG. 10 is a flow chart showing the listening and management of the old voice messages according to the present invention

### DETAILED DESCRIPTION OF THE PREFERRED EMBODIMENT

The present invention relates to a messaging management system and, more particularly, to a messaging management system and method for users roaming in a multi-campus enterprise mobile communication environment, wherein the voice messaging is transported only on demand so as to reduce the bandwidth requirement for the digital data network to lower the enterprise cost, and a Voice Messaging System Call-Back (VMS Call-Back) is provided to render the present invention as a user friendly system so as to prevent the subscribers from the problem of uncertain waiting time when the users listen to the voice messages which are transported among different campuses.

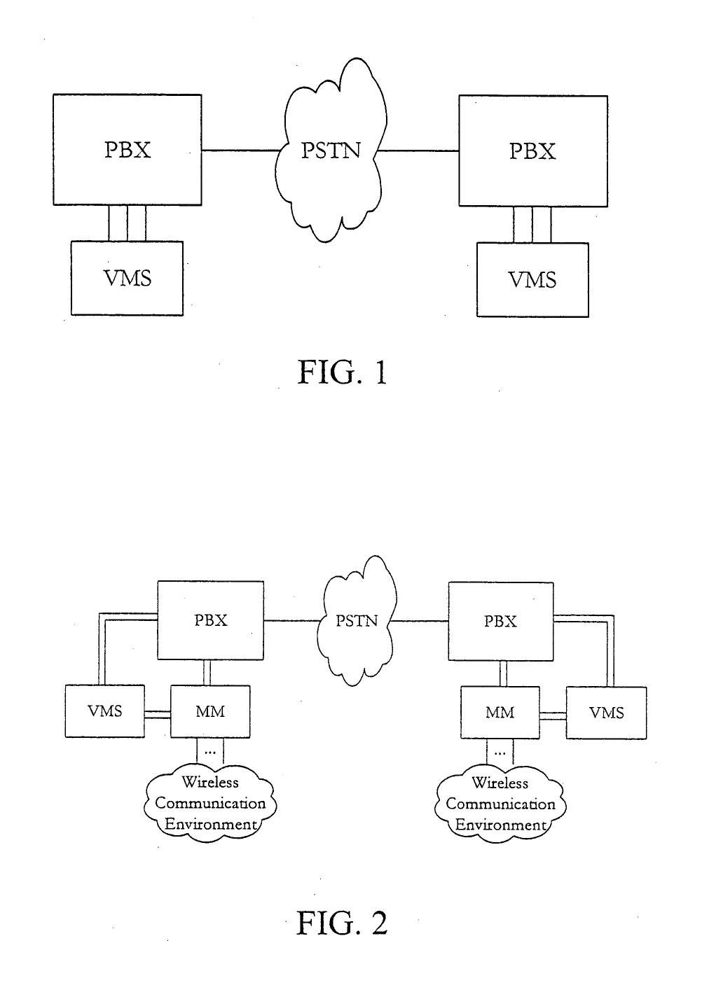

FIG. 1 is a diagram showing the conventional enterprise environment for wire communication and voice message system. The private branch exchange (hereinafter referred as PBX) and the voice messaging system (hereinafter referred as VMS) are generally connected by several private telephone lines which constitutes a hunt group (hereinafter referred as HG) and one number of the several private telephone lines is assigned as the representative number of the system. When the subscriber's phone is busy, no response or powered off, the message recording criteria are met and the message is left through the HG in the voice mail box (hereinafter referred as VMB) of the subscriber in the VMS. The identifying number of the subscriber is generally his corresponding directory number (hereinafter referred as DN), and the subscriber can listen to his messages in the VMS through his identifying number. Every campus of the enterprise has a VMS, and the messages for a subscriber roaming in from another campus are stored locally at the VMS of this roaming campus. When the subscriber intends to manage his messages, he can dial the representative number of VMS to access his messages.

The “enterprise environment” referred herein is a general term and includes all kinds of organization, corporation and private environment. The services for the VMS include, but are not limited to, recording messages for the called subscriber who is unable to take the phone call, notifying the called subscriber, listening and managing the messages by the called subscriber.

FIG. 2 is a diagram showing the enterprise environment for mobile communication and voice messaging system. The mobility manager (MM) handles the calling requests for the home subscribers or the roaming subscribers, including registration, authentication, call origination, call delivery, call forward etc. The present invention will describe the functions for subscriber roaming, message recording and message management. The other functions have been well known in this art and thus are not described herein.

When the subscriber roams to another campus, the subscriber's mobile phone must be registered with the mobile manager of the roaming campus firstly. The mobility manager of the roaming campus might already have had all subscribers' information of the enterprise. If not, the mobility manager of the roaming campus can ask the mobility manager in the subscriber's home campus for authentication so as to allow the roaming subscriber to register with the mobility manager in the roaming campus. After registration, the mobility manager assigns a roaming number (RN) to the subscriber. Thereafter, all calls made to the roaming subscriber are forwarded to the roaming campus through the roaming number. The present invention utilizes the roaming number as the identifying number of the voice messaging system such that the messages can be stored at the voice messaging system of the roaming campus and are not required to be forwarded to and stored at the home campus. The roaming subscriber is also not required to access his message from his home campus. Accordingly, the present invention significantly reduces the requirement for transporting the messages backward and forward between the roaming campus and the home campus and lowers the bandwidth requirement for the digital data network.

However, allowing the messages stored at the roaming campus results in the condition that the messages are distributed over various campuses. The present invention provides a novel system and method to use a unique VMS access number in all various campuses of the enterprise for accessing the voice messaging systems, which not only can avoid the subscriber from remembering several VMS access numbers but also enable the subscriber to obtain the newest information of the voice messages from the correct location that is managed by the mobility manager. When the subscriber intends to listen to the messages left at the home campus but the bandwidth of the digital data network is not enough or too busy to transport the messages to the roaming campus in time, the present invention further provides a call back system and method to maintain the normal operation of the voice messaging system and eliminate the requirement for increasing the capacity of the digital data network of the enterprise.

The environment in accordance with the present invention is related to a private mobile communication network including several campuses, wherein the network is consisted of a plurality of systems, each system serving a campus. For explanation purpose, the present invention describes an enterprise environment having three campuses, but the present invention is not limited to three campuses. It should be understood that the present invention can be applied to the enterprise environment having two, four or more campuses.

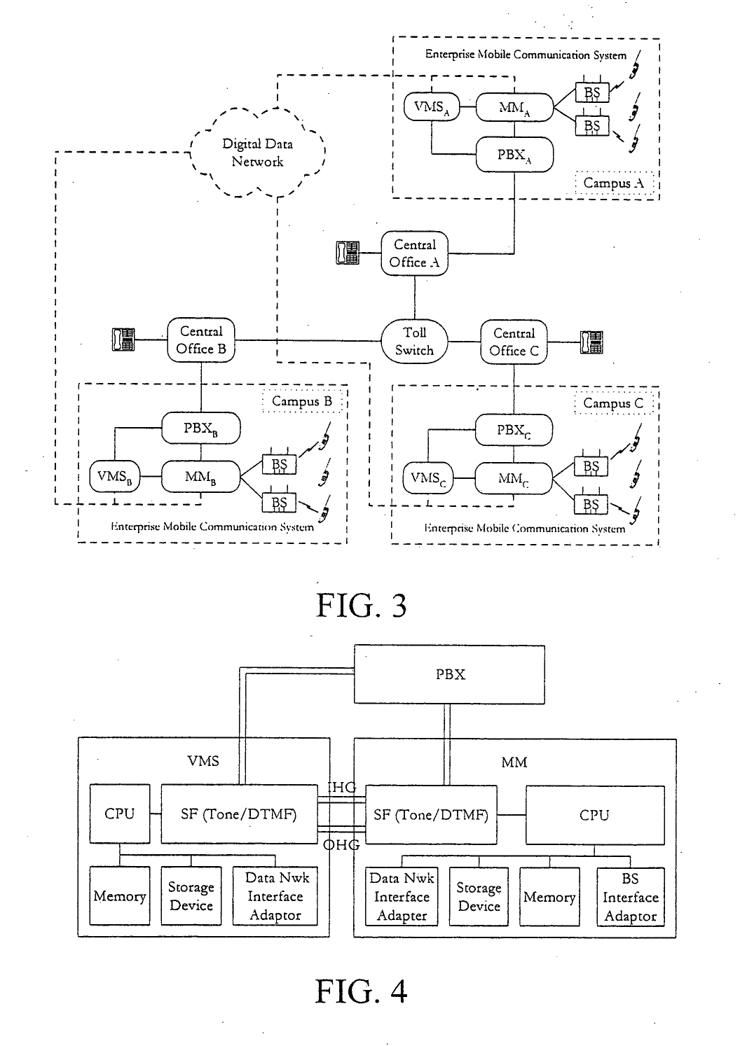

FIG. 3 illustrates a diagram showing the multi-campus enterprise environment for mobile communication and voice message system, wherein the environment has three campuses A, B and C. Campus A comprises a private branch exchange (PBX_{A}), a mobility manager (MM_{A}), a voice messaging system (VMS_{A}), a plurality of base stations (BS) and mobile phones. Between the mobility manager (MM_{A}) and the base stations (BS) is optionally provided with a base station controller to assist the mobility manager (MM_{A}) for controlling the transport of registration, call origination and call delivery from the mobile phones to the base station. The PBX_{A} and the MM_{A} can be integrated as a Wireless PBX_{A}. The PBX_{A} is connected to a central office A of public switched telephone network (PSTN). If the distance between the campuses is too long, there may be a toll switch in the communication path between the two campuses. If the distance between the campuses is not far away, their PBXes can be connected to the same central office thus no toll switch will be included in the communication path. MM_{A} supports the mobile communication capability and allows the mobile subscribers' registration, call origination, call forward and voice messaging. PBX_{A} controls the incoming and outgoing calls of PSTN and connects these calls to the wireless communication equipment, such as the BS. The storage and management of the voice messages for enterprise users are connected through hunt group (HG) to VMS_{A} which provides the storage and access of the voice messages and other managing function. Since the roaming information and voice messages for all campuses should be transported to one another, both VMS_{A} and MM_{A} are connected to a digital data network for transporting the roaming information and voice messages. The digital data network can be a private trunk, integrated service digital network (ISDN), asynchronous transfer mode (ATM) or other digital data network. It should be understood that campus B and campus C have the similar configuration as that of campus A. Description of campus B and campus C is eliminated due to its similarity to that of campus A.

FIG. 4 is a diagram showing the internal structures of the mobility manager and the voice messaging system. The mobility manager (MM) mainly includes a central processing unit (CPU) controlling a switch fabric (SF), a data network interface adapter, a storage device, a memory and a base station interface adapter. The voice messaging system (VMS) mainly includes a central processing unit (CPU) controlling a switch fabric (SF), a data network interface adapter, a storage device, and a memory. The switch fabric of the voice messaging system includes tone or dual tone multi-frequency signal (DTMF) source to produce tone or to decode the subscribers' dialing number on the voice connections. The data network interface adapter is connected to a digital data network. The incoming hunt group (IHG) is the private line of the voice messaging system for accessing the voice messages and the outgoing hunt group (OHG) is the private line of the voice messaging system for call back. The base station interface adapter of the mobility manager is connected to the base station for processing the registration, call origination and call delivery etc. of the mobile phones.

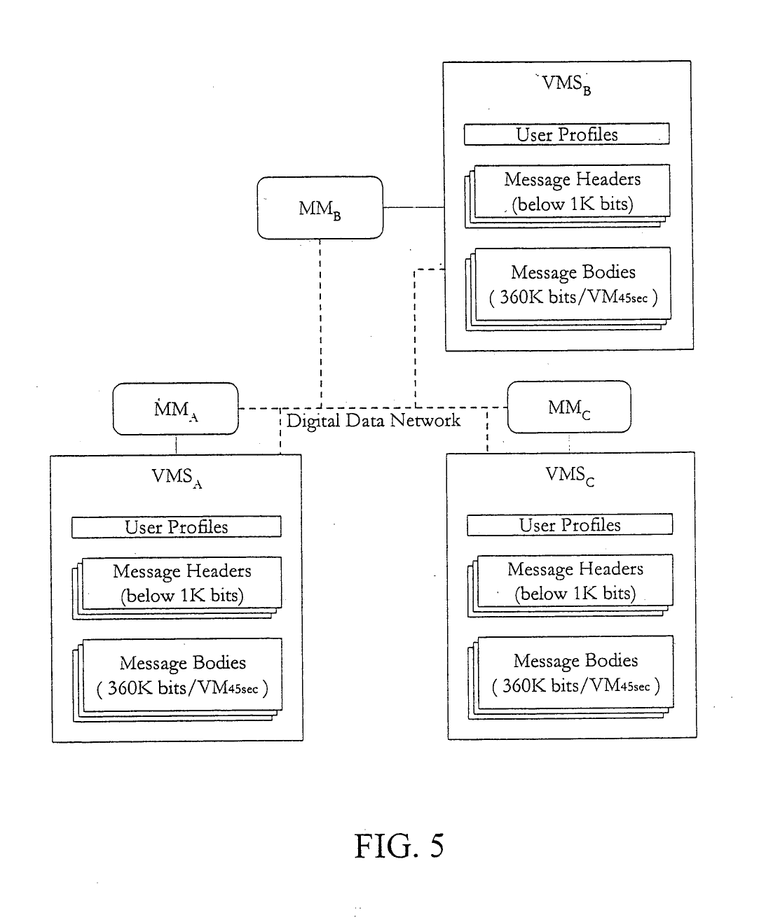

FIG. 5 is a diagram showing the internal structures of the voice messaging system according to the present invention. VMS_{A}, VMS_{B} and VMS_{C} are respectively connected to its MM_{A}, MM_{B} and MM_{C}. VMS_{A}, VMS_{B}, VMS_{C}, MM_{A}, MM_{B} and MM_{C} are connected together by a digital data network for transporting their message information. Each VMS contains information such as user profiles, message headers and message bodies. Generally, the information size of the message header is much less than that of the message body. For example, the information size of the message header is generally less than 1K bits and the compressed information size of a 45-seconds voice message body could be about 360K bits.

The messaging management system and method for users roaming in a multi-campus enterprise mobile communication environment in accordance with the present invention will become more apparent from the descriptions of registration, message recording, message listening and management. The detailed descriptions thereof are set forth below.

### REGISTRATION

For explanation, it is assumed that subscriber U_{A} of campus A roams from campus A to campus B, and subsequently to campus C, and U_{A} has messages left at campuses A, B and C. According to the present invention, the mobile subscribers are not required to arrange their voice mail box (VMB). After registered with the roaming campus, the RN assigned to the subscriber is used as the identification number for the roaming VMB. The roaming VMB and the home VMB belong to the same subscriber. Accordingly, the RN and the subscribers' directory number (I)N) are corresponding with each other and the required corresponding information can be obtained from the mobility manager. Since it's not necessary to explicitly define a specific database for mapping these correspondence, the way of correlating DN and RN is not further described.

Before the subscriber registered with the roaming campus, the newest message header is stored at his home campus. After registration with the roaming campus, the subscriber must obtain his message header from his home campus such that the subscriber is provided with the correct information. According to the present invention, the message body is not transported at the time of registration. After registration, all new message header will be stored at the VMS of the roaming campus such that the roaming campus begins to store the newest and the most complete information for the message header and the newly added voice message bodies.

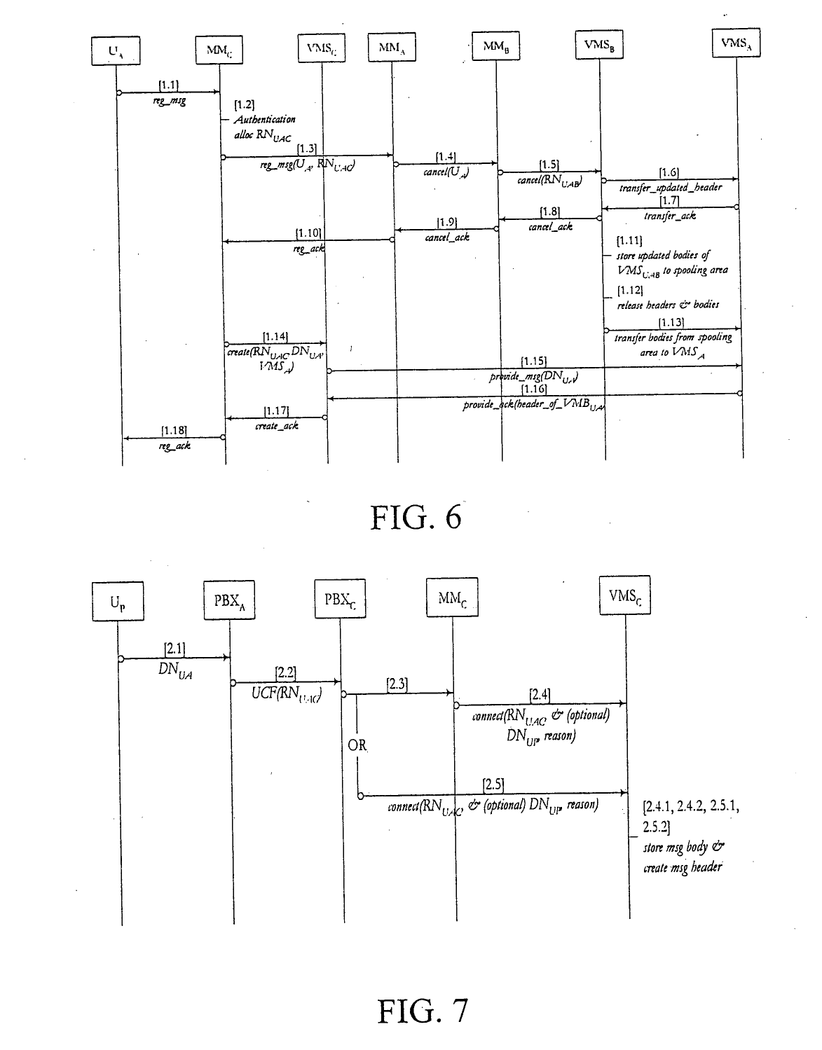

FIG. 6 is a flow chart showing the subscriber's registration with the roaming campus according to the present invention. The following steps describe in detail the processes for the mobility manager system and the VMS when the subscriber of campus A, U_{A} for example, leaves from the roaming campus B and registers with a new campus C.

Step 1.1: When the subscriber U_{A} roams to campus C, U_{A} sends a registration request message (reg_msg) to the campus C.

Step 1.2: After MM_{C} receives the registration request message (reg_msg), MM_{C} will authenticate whether U_{A} is a subscriber within the mobile communication network. After authentication, MM_{C} will assign a roaming number RN_{UAC} to U_{A.}

Step 1.3: After MM_{C} finished the authentication and assignment of RN, MM_{C} sends to U_{A}'s home campus a registration message (reg_msg) with the registration information including the subscriber's DN_{UA} and roaming number RN_{UAC}.

Step 1.4: After MM_{A} is informed that U_{A} has roamed from campus B to campus C, MM_{A} sends to MM_{B} a message (cancel) to cancel U_{A}'s resource at MM_{B}.

Step 1.5: After MM_{B} received MM_{A}'s cancel message, MM_{B} has to cancel RN_{UAB} (i.e. U_{A}) and U_{A}'s resources at VMS_{B}. Thus, MM_{B} sends to VMS_{B} a message (cancel) to cancel U_{A}'s resource at VMS_{B}.

Step 1.6: Since VMS_{B} has the most updated version of U_{A}'s message header, VMS_{B} has to transport the most updated version of U_{A}'s message header to U_{A}'s home campus. After VMS_{B} received the message (cancel), VMS_{B} sends a message (transfer_updated_header) with updated message header to VMS_{A}.

Step 1.7: After VMS_{A} received the message (transfer_updated_header) with updated message header, VMS_{A} stores the updated message header and then sends a message (transfer_ack) to VMS_{B} as acknowledgement.

Step 1.8: After VMS_{B} received the message (transfer_ack) from VMS_{A} learning that VMS_{A} has had the updated message header, VMS_{B} sends an acknowledgement message (cancel_ack) to MM_{B}.

Step 1.9: From VMS_{B} 's message (cancel_ack), MM_{B} makes sure that the previous cancel procedure is successful, and thus sends a message (cancel_ack) to MM_{A}. At this time, resources allocated for U_{A} in MM_{B} (RN_{UAB} for example) can be released.

Step 1.10: After MM_{A} received MM_{B}'s message (cancel_ack), MM_{A} responds to MM_{C} a message (reg_ack) informing that MM_{A} knows U_{A} roams to campus C and begins to update and transport the necessary data.

Step 1.11: After VMS_{A} has confirmed to receive U_{A}'s updated message header from VMS_{B}, VMS_{B} stores U_{A}'s updated message body at the spooling area which will be transported later.

Step 1.12: After VMS_{B} has stored all data at the spooling area, U_{A}'s message header, message body and VMB can be released from VMS_{B}.

Step 1.13: Since the message body stored at the spooling area in Step 1.11 is not yet transported to VMS_{A}, the system should transport the message body stored at the spooling area to VMS_{A},

Step 1.14: After receiving MM_{A}'s registration response, MM_{C} sends a message (create) to VMS_{C} to create a voice mail box for RN_{UAC} (U_{A}). The message (create) is attached with U_{A}'s DN_{UA} and address of VMS_{A}.

Step 1.15: After VMS_{C} received the message (create), VMS_{C} creates a voice mail box for RN_{UAC} (U_{A}) and sends a message (provide_msg) to VMS_{A} to request U_{A}'s message header to ensure having the subscriber's most updated message header information.

Step 1.16: Receiving VMS_{C}'s message (provide_msg), VMS_{A} sends a message (provide_ack) to VMS_{C} along with U_{A}'s message header.

Step 1.17: Once U_{A}'s voice mail box is established and U_{A}'s message header is stored at VMS_{C}, VMS_{C} sends a message (create_ack) to MM_{C}.

Step 1.18: After MM_{C} received the message (create_ack) which means that U_{A}'s roaming voice mail box and message header have been established, MM_{C} sends a message (reg_ack) to inform U_{A} success of registration.

According to the above steps, the previously roaming campus VMS_{B} firstly transports the message header with less information size back to the VMS_{A} of the home campus such that the roaming subscriber can complete his registration. The message body with larger information size is stored at the spooling area firstly and will be transported later. When the information is stored at the spooling area, the space occupied by the message body will be released for other subscribers' use. Since the present invention is provided with call-back function (described below), the actual message contents are allowed to be transported later.

### MESSAGE RECORDING

Referring to FIG. 7, it shows a flow chart for the message recording according to the present invention. Supposing that a subscriber Uₚ of PSTN makes a call to U_{A} who has roamed to campus C and is unable to take the call, the system will transfer the call to VMS_{C}.

Step 2.1: A subscriber Uₚ dials U_{A}'s DN_{UA}, and the call is connected to PBX_{A}.

Step 2.2: According to U_{A}'s registration with campus C, PBX_{A} forwards the call to RN_{UAC} of PBX_{C}.

Step 2.3: PBX_{C} finds that U_{A} is a mobile subscriber, and thus PBX_{C} delivers the call to MM_{C}.

Step 2.4: If the message recording criteria are met during MM_{C}'s processing, SF of MM_{C} connects the call to VMS_{C}, then RN_{UAC}, caller's DN_{UP}, and recording reason are sent to VMS_{C}. Please note that the caller's DN_{UP}, and recording reason are optional for they may be unavailable in some systems. With these messages, VMS owner can have more information about the voice message. However, VMS_{C} still can store the message at the corresponding VMB in accordance with RN_{UAC}.

Step 2.4.1: VMS_{C} stores the message body of the recorded message.

Step 2.4.2: VMS_{C} creates a message header for the recorded message.

Another message recording path is employed when PBX_{C} detects that a call is not answered or the call could not be answered. In this case, PBX_{C} redirect the call to VMS_{C}.

Step 2.5: If PBX_{C} finds that RN_{UAC} is busy, PBX_{C} sends RN_{UAC}, caller's DN_{UP}, and recording reason to VMS_{C} for storing. Please note that caller's DN_{UP}, and recording reason are optional due to the same reason as that in step 2.4.

Step 2.5.1: the same as Step 2.4.1, VMS_{C} stores the message body of the recorded message.

Step 2.5.2: the same as Step 2.4.2, VMS_{C} creates a message header for the recorded message.

### LISTENING AND MANAGING

The followings depict that the subscriber U_{A} is roaming at campus C and intends to listen to or to manage his own VMB. U_{A} dials DN_{VMS} which is a common representative number for all campuses, instead of a particular number of a certain campus's VMS. When MM receives DN_{VMS} dialed by U_{A}, MM transfers it into the DN of roaming campus's VMS, i.e., DN_{VMSC}. Since only the roaming campus has the up-to-date message header information after U_{A}'s registration, connecting the call to VMS_{C} can ensure what the subscriber U_{A} accesses to is the most updated VMB information. If the system connects U_{A} to VMS_{A} in his home campus, U_{A} will have access to the incorrect VMB information.

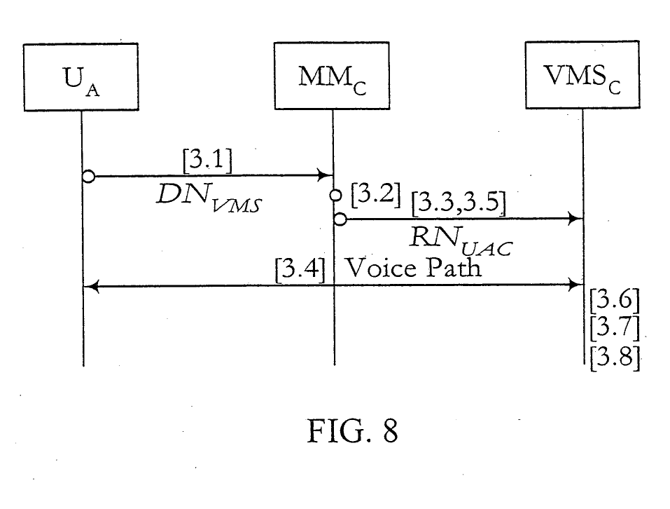

FIG. 8 is a flow chart showing the listening and management of the voice messages according to the present invention. The following steps describe the listening and management of the voice messages according to the present invention.

Step 3.1: U_{A} dials DN_{VMS} to gain access to the VMS wherein DN_{VMS} is a common representative number for all campuses.

Step 3.2: When SF of MM_{C} receives DN_{VMS}, MM_{C} automatically transfers it into the DN_{VMSC} for VMS_{C}.

Step 3.3: SF of MM_{C} connects to VMS_{C} through DN_{VMSC}.

Step 3.4: SF of MM_{C} connects to SF of VMS_{C} and creates a voice path.

Step 3.5: The system subsequently transports RN_{UAC} to VMS_{C} by means of data link, voice path or other manner.

Step 3.6: VMS_{C} locates the corresponding VMB_{RNUAC} according to RN_{UAC}.

Step 3.7: VMS_{C} plays to U_{A} his message information, unread messages, old messages and management menu by means of the voice path.

Step 3.8: U_{A} inputs his option and the DTMF receiver of VMS_{C} decodes the option for processing by the programs of the VMS.

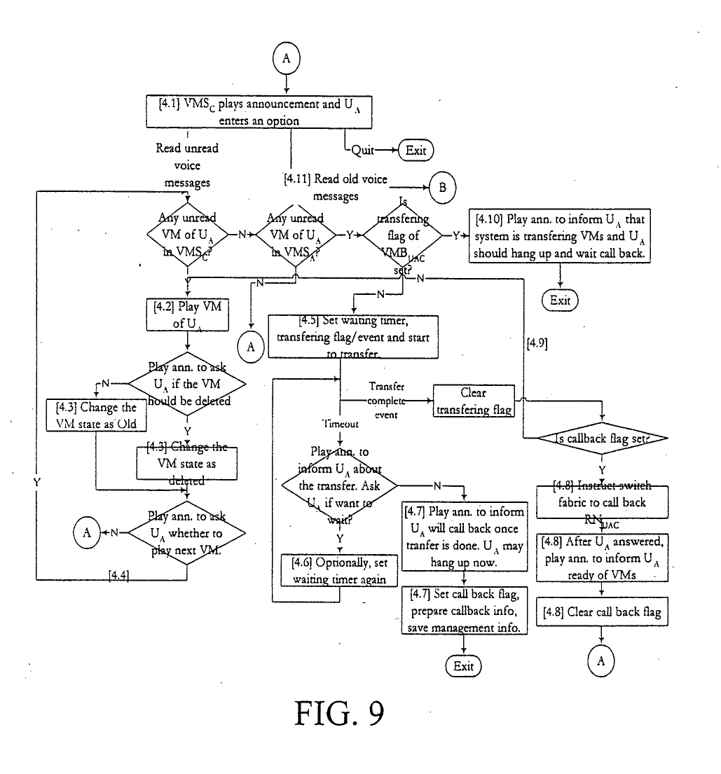

FIG. 9 is a flow chart showing the listening and management of the unread voice messages according to the present invention. The steps are described below.

Step 4.1: VMS_{C} plays the main menu of voice messaging service and asks U_{A} to enter a choice, wherein the main menu items includes reading the unread voice messages, reading old voice messages and exit.

Step 4.2: If U_{A} selects reading unread voice messages and there is an unread message in VMS_{C}, VMS_{C} plays this unread message to U_{A}.

Step 4.3: After reading the unread message, U_{A} can select whether the message should be “deleted”. If U_{A} selects deletion, the voice message state on header is changed as deleted. If U_{A} selects not to delete, the voice message state is changed as “old”.

Step 4.4: If U_{A} selects to read the next voice message and the voice message is stored in VMS_{C}, go to Step 4.2. Otherwise, go to Step 4.5 or Step 4.10 according to conditions stated in these steps.

Step 4.5: If U_{A} selects to continue to read the unread voice messages in VMS_{A}, VMS_{C} must set the waiting time, and transferring flag for the voice messages, and starts to transport U_{A}'s voice messages in VMS_{A}. VMS_{C} waits for the completion of the message transportation. As to the unread messages in VMS_{A}, the system has two options: one is to transport only one message at a time and to transport the next one if the subscriber selects, the other is to transport all unread voice messages in VMS_{A} to VMS_{C}. For convenience, the present embodiment takes the second option as an example.

Step 4.6: If the voice messages are not completely transported in time before the waiting timer is timeout, the subscriber can select to continue waiting for the message transportation. At this time, the system can optionally reset a waiting timer again and ask U_{A} if he wants to wait again. The value of the timeout period can be set through the managing interface by the system.

Step 4.7: If U_{A} does not want to wait after timeout, VMS_{C} plays an announcement to inform U_{A} to hang up the call, and VMS_{C} will automatically call back to U_{A} after the messages have been completely transported. At this time, the system sets a callback flag for U_{A}'s VMB and prepares for callback messages.

Step 4.8: If the system receives the transfer complete event after U_{A}'s callback flag is set, VMS_{C} will order SF to call U_{A}, plays an announcement to inform U_{A} that the messages are ready, and plays the messages to U_{A}. At the same time, U_{A}'s callback flag is cleared.

Step 4.9: If the system receives the transfer complete event but U_{A}'s callback flag is not set which means that U_{A} is still waiting for the messages, the system will go to Step 4.2 to play the messages transported from VMS_{A} to U_{A}.

Step 4.10: If U_{A} has hanged up the call and waited for callback during transporting messages from VMS_{A} to VMS_{C} but calls VMS_{C} again for his messages, VMS_{C} knowing that the system is transferring the subscriber's messages, plays an announcement to inform U_{A} to hang up and wait for VMS_{C}'s callback.

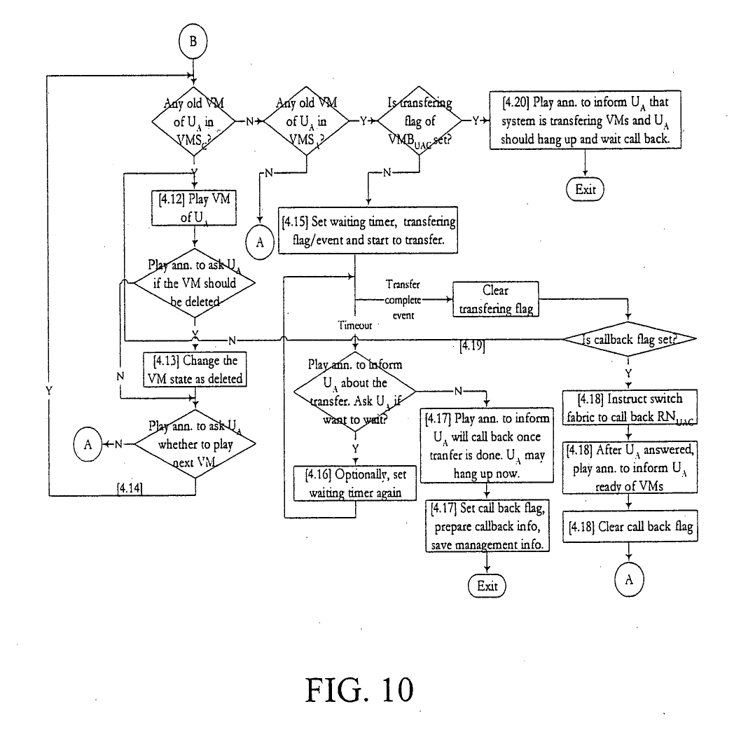

Step 4.11: Referring to FIG. 10.

Step 4.12: If U_{A} selects reading old voice messages and there is an old message in VMS_{C}, VMS_{C} plays this old message to U_{A}.

Step 4.13: After reading the old message, U_{A} can select whether the message should be deleted. If U_{A} selects deletion, the voice message state on header is changed as deleted.

Step 4.14: If U_{A} selects to read the next voice message, and the voice message is stored in VMS_{C} go to Step 4.12.

Step 4.15: If U_{A} selects to continue to read the next old voice messages but it is stored in VMS_{A}, VMS_{C} must set the waiting timer, and transferring flag for the voice messages, and starts to transport U_{A}'s old voice, messages in VMS_{A}. VMS_{C} waits for the completion of the message transportation. As to the old messages in VMS_{A}, the system has two options: one is to transport only one message at a time and to transport the next one if the subscriber selects, the other is to transport all old voice messages in VMS_{A} to VMS_{C}. For convenience, the present embodiment takes the second option as an example.

Step 4.16: As in Step 4.6, if the old voice messages are not completely transported in time before the waiting timer is timeout, the subscriber can select to continue waiting for the message transportation. At this time, the system can optionally reset a waiting timer again and ask U_{A} if he wants to wait again. The value of the timeout period can be set through the managing interface by the system.

Step 4.17: As in Step 4.7, if U_{A} does not want to wait after timeout, VMS_{C} plays an announcement to inform U_{A} to hang up the call, and VMS_{C} will automatically call back to U_{A} after the messages have been completely transported. At this time, the system sets a callback flag for U_{A}'s VMB and prepares for callback messages.

Step 4.18: As in Step 4.8, if the system receives the transfer complete event after U_{A}'s callback flag is set, VMS_{C} will order SF to call U_{A}, plays an announcement to inform U_{A} that the messages are ready after U_{A} answering, and plays the messages to U_{A}. At the same time, U_{A}'s callback flag is cleared.

Step 4.19: If the system receives the transfer complete event but U_{A}'s callback flag is not set which means that U_{A} is still waiting for the messages, the system will go to Step 4.12 to play the messages transported from VMS_{A} to U_{A}.

Step 4.20: As in Step 4.10, if U_{A} has hanged up the call and waited for callback during transporting messages from VMS_{A} to VMS_{C} but calls VMS_{C} again for his messages, VMS_{C}, knowing that the system is transferring the subscriber's messages, plays an announcement to inform U_{A} to hang up and wait for VMS_{C}'s callback.

As set forth in the above descriptions, the present invention utilizes the principle of transport on demand, wherein the messages stored at the roaming campus is played first when the subscriber intends to listen his messages (as set forth in Step 4.2 and Step 4.12), and the messages are transported only when the messages are stored at the home campus and are listened by the subscriber at the roaming campus. If the subscriber at the roaming campus does not listen to the messages stored at the home campus, there is no requirement for transporting the messages and for occupying the storing space of the VMS of the roaming campus for storing the unused messages. In the same way, if the subscriber listens the messages stored at the roaming campus and then delete them, the messages are not required to be transported back to and occupy the storing space of VMS_{A}. The present invention further provides a callback mechanism (as set forth in Step 4.8 and Step 4.18) in such a manner that the messages required long transporting time can be continuously transported and the subscriber will not waste time for waiting (as set forth in Step 4.7 and Step 4.17). After the long messages are completely transported, the VMS calls back to the subscriber to continue to manage his messages.

The system and method of the present invention not only significantly lower the unnecessary transport of the voice messaging but also can operate under the condition of insufficient digital data network bandwidth, which can reduce the cost for network bandwidth and loosen up the operation requirements for the voice messaging system. At the same time, the subscribers of the present invention are not required to memorize several sets of representative numbers for the VMS at different campuses, which renders the present invention a user friendly and competitive system.

Although the invention has been explained in relation to its preferred embodiment, it is to be understood that many other possible modifications and variations can be made without departing from the spirit and scope of the invention as hereinafter claimed.

What is claimed is:

1. A mobility management system for users roaming in a multi-campus enterprise mobile communication environment, comprising:
a first campus having a first wireless PBX_{A}, a first voice messaging system (VMS_{A}), a plurality of first base stations (BS) and mobile phones;
a first central office connected to the first wireless PBX_{A};
a second campus having a second wireless PBX_{B}, a second voice messaging system (VMS_{B}), a plurality of second base stations (BS) and mobile phones;
a second central office connected to the second wireless PBX_{B} and the first central office; and
a digital data network for connecting the first wireless PBX_{A}, the first voice messaging system (VMS_{A}), the second wireless PBX_{B}, and the second voice messaging system (VMS_{B}).

2. The mobility management system as claimed in claim 1, wherein the first wireless PBX_{A}, and the second wireless PBX_{B} are connected to at least one of the central office.

3. The mobility management system as claimed in claim 1, wherein the first wireless PBX_{A} includes a first PBX_{A} and a first mobility manager (MM_{A}).

4. The mobility management system as claimed in claim 1, wherein the second wireless PBX_{B} includes a second PBX_{B} and a second mobility manager (MM_{B}).

5. The mobility management system as claimed in claim 1, wherein each mobility manager includes a central processing unit (CPU) controlling a switch fabric (SF), a data network interface adapter, a storage device, a memory and a base station interface adapter.

6. The mobility management system as claimed in claim 1, wherein each voice messaging system (VMS) includes a central processing unit (CPU) controlling a switch fabric (SF), a data network interface adapter, a storage device, and a memory.

7. A mobility management method for users roaming in a multi-campus enterprise mobile communication environment, a user U_{A} roaming from a home campus to a new roaming campus C, the method comprising the following steps:
the user U_{A} registering with the new roaming campus C;
after U_{A}'s registration, an updated message header for U_{A} being transported from the home campus to the new roaming campus C, and all new messages being stored at the VMS of the new campus;
when Uₚ calling U_{A} who is unable to take Uₚ's call, Uₚ's call being transferred to the VMS of the new campus for recording message;
U_{A} dialing a common DN_{VMS} and connecting to the VMS of the new campus C for listening to and managing his own VMB; and
the VMS of the new campus playing to U_{A} a main menu including reading the unread voice messages, reading old voice messages and exit.

8. The method as claimed in claim 7, wherein the user U_{A} leaves campus A to campus B, and then roams to campus C and the U_{A} registers with campus C, the registration method comprises the following steps:
Step 1.1: U_{A} sending a registration request message (reg_msg) to a MM_{C} of the campus C, when U_{A} roams to the campus C;
Step 1.2: after MM_{C} receiving the registration request message (reg_msg), MM_{C} authenticating whether U_{A} is a subscriber within the mobile communication network and assigning a roaming number RN_{UAC} to U_{A} after authentication;
Step 1.3: after MM_{C}'s authentication and assignment of RN, MM_{C} sending to U_{A}'s home campus a registration message (reg_msg) with the registration information including the subscriber's DN_{UA} and roaming number RN_{UAC};
Step 1.4: after MM_{A} being informed that U_{A} has roamed from a campus B to the campus C, MM_{A} sending to MM_{B} a message (cancel) to cancel U_{A}'s resource at MM_{B};
Step 1.5: after MM_{B} receiving MM_{A}'s cancel message, MM_{B} sending to VMS_{B} a message (cancel) to cancel U_{A}'s resource at VMS_{B}.
Step 1.6: after VMS_{B} receiving the message (cancel), VMS_{B} sending a message (transfer_updated_header) with-updated message header to VMS_{A;}
Step 1.7: after VMS_{A} receiving the message (transfer_updated_header) with updated message header, VMS_{A} storing the updated message header and sending a message (transfer_ack) to VMS_{B} as acknowledgement;
Step 1.8: after VMS_{B} receiving the message (transfer_ack) from VMS_{A} learning that VMS_{A} has had the updated message header, VMS_{B} sending a message (cancel_ack) to MM_{B};
Step 1.9: MM_{B} sending a message (cancel_ack) to MM_{A};
Step 1.10: after MM_{A} receiving MM_{B}'s message (cancel_ack), MM_{A} responding to MM_{C} a message (reg_ack) informing that MM_{A} knows U_{A} roams to the campus C and begins to update and transport the necessary data;
Step 1.11: after VMS_{A} having confirmed to receive U_{A}'s updated message header from VMS_{B}, VMS_{B} storing U_{A}'s updated message body at the spooling area which will be transported later;
Step 1.12: after VMS_{B} having stored all data at the spooling area, U_{A}'s message header, message body and VMB being released from VMS_{B};
Step 1.13: since the message body stored at the spooling area in Step 1.11 is not yet transported to VMS_{A}, the system having to transport the message body stored at the spooling area to VMS_{A};
Step 1.14: after receiving MM_{A}'s registration response, MM_{C} sending a message (create) to VMS_{C} to create a voice mail box for RN_{UAC} (U_{A}), the message (create) being attached with U_{A}'s DN_{UA} and address of VMS_{A};
Step 1.15: after VMS_{C} receiving the message (create), VMS_{C} creating a voice mail box for RN_{UAC} (U_{A}) and sending a message (provide_msg) to VMS_{A} to request all U_{A}'s message header to ensure having the subscriber's updated message header information;
Step 1.16: receiving VMS_{C}'s message (provide_msg), VMS_{A} sending a message (provide_ack) to VMS_{C} along with U_{A}'s message header;
Step 1.17: once U_{A}'s voice mail box being established and U_{A}'s message header being stored at VMS_{C}, VMS_{C} sending a message (create_ack) to MM_{C}; and
Step 1.18: after MM_{C} receiving the message (create_ack) which means that U_{A}'s roaming voice mail box and message header have been established, MM_{C} sending a message (reg_ack) to inform U_{A} success of registration.

9. The method as claimed in claim 7, wherein the message recording comprises the following steps of:
Step 2.1: a subscriber Uₚ dialing U_{A}'s DN_{UA}, and the call being connected to PBX_{A};
Step 2.2: according to U_{A}'s registration with campus C, PBX_{A} forwarding the call to RN_{UAC} of PBX_{C};
Step 2.3: PBX_{C} delivering the call to MM_{C};
Step 2.4: if the message recording criteria are met during MM_{C}'s processing, SF of MM_{C} connecting the call to VMS_{C}, then RN_{UAC} being sent to VMS_{C};
Step 2.4.1: VMS_{C} storing the message body of the recorded message; and
Step 2.4.2: VMS_{C} creating a message header for the recorded message.

10. The method as claimed in claim 7, wherein the recording message comprises the following steps of:
Step 2.1: a subscriber Uₚ dialing U_{A}'s DN_{UA}, and the call being connected to PBX_{A};
Step 2.2: according to U_{A}'s registration with campus C, PBX_{A} forwarding the call to RN_{UAC} of PBX_{C};
Step 2.3: PBX_{C} transferring the call to MM_{C};
Step 2.5: If PBX_{C} finds that RN_{UAC} is busy, PBX_{C} sending RN_{UAC}, caller's DN_{UP}, and recording reason to VMS_{C} for storing;
Step 2.5.1: VMS_{C} storing the message body of the recorded message; and
Step 2.5.2: VMS_{C} creating a message header for the recorded message.

11. The method as claimed in claim 7, wherein U_{A}'s listening to and managing his own VMB at the campus C comprising the following steps of:
Step 3.1: U_{A} dialing DN_{VMS} for access to the VMS wherein DN_{VMS} is a common representative number for all campuses;
Step 3.2: when SF of MM_{C} receiving DN_{VMS, MM}_{C} automatically transferring it into the DN_{VMSC} for VMS_{C};
Step 3.3: SF of MM_{C} connecting to VMS_{C} through DN_{VMSC};
Step 3.4: SF of MM_{C} connecting to SF of VMS_{C} and creating a voice path;
Step 3.5: the system subsequently transporting RN_{UAC} to VMS_{C} by means of data link, voice path or other manner;
Step 3.6: VMS_{C} locating the corresponding VMB _{RNUAC} according to RN_{UAC};
Step 3.7: VMS_{C} playing to U_{A} his message information, unread messages, old messages and management menu by means of the voice path; and
Step 3.8: U_{A} entering his option and the DTMF receiver of VMS_{C} decoding the option for processing by the programs of the VMS.

12. The method as claimed in claim 7, wherein U_{A}'s listening to and managing his unread messages at the campus C comprising the following steps of:
Step 4.1: VMS_{C} playing the main menu of voice messaging service and ask U_{A} to enter a choice, wherein the main menu items includes reading the unread voice messages, reading old voice messages and exit;
Step 4.2: if U_{A} selects reading unread voice messages and there is an unread message in VMS_{C}, VMS_{C} playing this unread message to U_{A};
Step 4.3: after reading the unread message, U_{A} selecting whether the message should be deleted; if so, the voice message state on header being changed as “deleted”; if not, the voice message state being changed as old; and
Step 4.4: if U_{A} selecting to read the next voice message, and the voice message being stored in VMS_{C} go to Step 4.2.

13. The method as claimed in claim 7, wherein wherein U_{A}‘s listening to and managing his unread messages at the campus C comprising the following steps of:
Step 4.1: VMS_{C} playing the main menu of voice messaging service and ask U_{A} to enter a choice, wherein the main menu items includes reading the unread voice messages, reading old voice messages and exit;
Step 4.5: if U_{A} selects to continue to read the unread voice messages but they are stored in VMS_{A}, VMS_{C} having to set a waiting timer, and transferring flag for the voice messages, and starting to transport U_{A}'s voice messages in VMS_{A}; and
Step 4.6: if the voice messages are not completely transported in time before the waiting timer is timeout, the subscriber being able to select to continue waiting for the message transportation.

14. The method as claimed in claim 7, wherein U_{A}'s listening to and managing his unread messages at the campus C comprising the following steps of:
Step 4.1: VMS_{C} playing the main menu of voice messaging service and ask U_{A} to enter a choice, wherein the main menu items includes reading the unread voice messages, reading old voice message and exit;
Step 4.5: if U_{A} selects to continue to read the unread voice messages but they are stored in VMS_{A}, VMS_{C} having to set a waiting timer, and transferring flag for the voice messages, and starting to transport U_{A}'s voice messages in VMS_{A}; and
Step 4.7: if U_{A} does not want to wait after timeout, VMS_{C} playing an announcement to inform U_{A} to hang up the call, and VMS_{C} automatically calling back to U_{A} after the messages have been completely transported, wherein the system sets a callback flag for U_{A}'s VMB and prepares for callback messages.

15. The method as claimed in claim 7, wherein U_{A}'s listening to and managing his unread messages at the campus C comprising the following steps of:
Step 4.1: VMS_{C} playing the main menu of voice messaging service and ask U_{A} to enter a choice, wherein the main menu items includes reading the unread voice messages, reading old voice message and exit;
Step 4.5: if U_{A} selects to continue to read the unread voice messages but they are stored in VMS_{A}, VMS_{C} having to set a waiting time, and transferring flag for the voice messages, and starting to transport U_{A}'s voice messages in VMS_{A}; and
Step 4.8: if the system receives the transfer complete event after U_{A}'s callback flag is set, VMS_{C} ordering SF to call U_{A}, playing an announcement to inform U_{A} that the messages are ready, and playing the messages to U_{A}, and U_{A}'s callback flag being cleared.

16. The method as claimed in claim 7, wherein U_{A}'s listening to and managing his unread messages at the campus C comprising the following steps of:
Step 4.1: VMS_{C} playing the main menu of VMB for U_{A} option, wherein the main menu includes reading the unread voice messages, reading old voice message and exit;
Step 4.5: if U_{A} selects to continue to read the unread voice messages in VMS_{A}, VMS_{C} having to set a waiting time, and transferring flag for the voice messages, and starting to transport U_{A}'s voice messages in VMS_{A}; and
Step 4.9: if the system receives the transfer complete event but U_{A}'s callback flag is not set which means that U_{A} is still waiting for the messages, the system going to Step 4.2 to play the messages transported from VMS_{A} to U_{A}.

17. The method as claimed in claim 7, wherein U_{A}'s listening to and managing his unread messages at the campus C comprising the following steps of:
Step 4.1: VMS_{C} playing the main menu of voice messaging service and ask U_{A} to enter a choice, wherein the main menu items includes reading the unread voice messages, reading old voice message and exit;
Step 4.10: if U_{A} has hanged up the call and waited for callback during transporting messages from VMS_{A} to VMS_{C} but calls VMS_{C} again for his messages, VMS_{C} knowing that the system is transferring the subscriber's messages playing an announcement to inform U_{A} to hang up and wait for VMS_{C}'s callback.

18. The method as claimed in claim 7, wherein U_{A}'s listening to and managing his old messages at the campus C comprising the following steps of:
Step 4.12: if U_{A} selects reading old voice messages and there is an old message in VMS_{C}, VMS_{C} playing this old message to U_{A};
Step 4.13: after reading the old message, U_{A} being able to select whether the message should be deleted; If so, the header of the voice message state being changed as deleted.
Step 4.14: if U_{A} selects to read the next voice message, and the voice message is stored in VMS_{C}, going to Step 4.12.

19. The method as claimed in claim 7, wherein U_{A}'s listening to and managing his old messages at the campus C comprising the following steps of:
Step 4.15: if U_{A} selects to continue to read the old voice messages but they are stored in VMS_{A}, VMS_{C} having to set a waiting timer, and transferring flag for the voice messages, and starting to transport U_{A}'s old voice messages in VMS_{A};
Step 4.16: if the old voice messages are not completely transported in time before the waiting timer is timeout, the subscriber being able to select to continue waiting for the message transportation.

20. The method as claimed in claim 7, wherein U_{A}'s listening to and managing his old messages at the campus C comprising the following steps of:
Step 4.15: if U_{A} selects to continue to read the old voice messages but they are stored in VMS_{A}, VMS_{C} having to set a waiting timer, and transferring flag for the voice messages, and starting to transport U_{A}'s old voice messages in VMS_{A};
Step 4.17: if U_{A} does not want to wait after timeout, VMS_{C} playing an announcement to inform U_{A} to hang up the call, and VMS_{C} automatically calling back to U_{A} after the messages have been completely transported.

21. The method as claimed in claim 7, wherein U_{A}'s listening to and managing his old messages at the campus C comprising the following steps of:
Step 4.15: if U_{A} selects to continue to read the old voice messages but they are stored in VMS_{A}, VMS_{C} having to set a waiting timer, and transferring flag for the voice messages, and starting to transport U_{A}'s old voice messages in VMS_{A};
Step 4.18: if the system receives the transfer complete event after U_{A}'s callback flag is set, VMS_{C} ordering SF to call U_{A}, playing an announcement to inform U_{A} that the messages are ready after U_{A} answering, and playing the messages to U_{A}, and U_{A}'s callback flag being cleared.

22. The method as claimed in claim 7, wherein U_{A}'s listening to and managing his old messages at the campus C comprising the following steps of:
Step 4.15: if U_{A} selects to continue to read the old voice messages but they are stored in VMS_{A}, VMS_{C} having to set a waiting timer, and transferring flag for the voice messages, and starting to transport U_{A}'s old voice messages in VMS_{A};
Step 4.19: if the system receives the transfer complete event but U_{A}'s callback flag is not set which means that U_{A} is still waiting for the messages, the system going to Step 4.12 to play the messages transported from VMS_{A} to U_{A}.

23. The method as claimed in claim 7, wherein U_{A}'s listening to and managing his old messages at the campus C comprising the following steps of:
Step 4.15: if U_{A} selects to continue to read the old voice messages but they are stored in VMS_{A}, VMS_{C} having to set a waiting timer, and transferring flag for the voice messages, and starting to transport U_{A}'s old voice messages in VMS_{A};
Step 4.20: if U_{A} has hanged up the call and waited for callback during transporting messages from VMS_{A} to VMS_{C} but U_{A} calls VMS_{C} again for his messages, VMS_{C} knowing that the system is transferring the subscriber's messages, playing an announcement to inform U_{A} to hang up and wait for VMS_{C}'s callback.
